(19) United States
(12) Patent Application Publication
(10) Pub. No.: US 2017/0237838 A1
(43) Pub. Date: Aug. 17, 2017

(54) RESILIENT IMPLEMENTATION OF STREAM CONTROL TRANSMISSION PROTOCOL

(71) Applicant: Luminate Wireless Inc., Cupertino, CA (US)

(72) Inventors: Mark Vandevoorde, Sunnyvale, CA (US); Julien Bernard Pierre Philippe Pourtet, San Jose, CA (US); Andrew John Patti, Cupertino, CA (US); Ming Zhao, Sunnyvale, CA (US)

(21) Appl. No.: 15/436,677

(22) Filed: Feb. 17, 2017

Related U.S. Application Data
(60) Provisional application No. 62/296,519, filed on Feb. 17, 2016.

(51) Int. Cl. H04L 29/08; H04L 1/18; H04W 56/00

(52) U.S. Cl. CPC H04L 69/326; H04W 56/0015; H04L 1/1809; H04W 84/042

(57) ABSTRACT

Methods, systems, and apparatus, including computer programs, providing resilient SCTP stack operation. One method includes having a master and slave for a gateway, the master checkpointing key protocol state, including: for transmissions over an SCTP connection from an application to a peer, checkpointing the message payload when a message is received from the application and before it is pushed to the SCTP protocol; after transmitting data to the peer, checkpointing a stream ID, stream sequence number, and transmission sequence number (TSN) of each chunk; and on receiving a selective acknowledgement (SACK) that a chunk was received, deleting the chunk and checkpointing this deletion; and for receptions of data: on receiving a chunk from the peer, checkpointing a message payload, stream ID, stream sequence number, and TSN before sending a SACK; and upon delivery of a message to the application, deleting the message from the SCTP stack and checkpointing the deletion.

### CROSS-REFERENCE TO RELATED APPLICATIONS

This application claims the benefit under 35 U.S.C. §119(e) of the filing date of U.S. Patent Application No. 62/296,519, for Resilient Implementation Of Stream Control Transmission Protocol, which was filed on Feb. 17, 2016, and which is incorporated here by reference.

### BACKGROUND

This specification relates to implementations of the Stream Control Transmission Protocol.

Stream Control Transmission Protocol (SCTP) is a transport layer serving a role similar to that of Transmission Control Protocol (TCP) and User Datagram Protocol (UDP). SCTP provides some of the same service features of both: it is message-oriented like UDP and ensures reliable, in-sequence transport of messages with congestion control like TCP. It is possible to tunnel SCTP over UDP, as well as mapping TCP API (application programming interface) calls to SCTP calls. RFC4960 is a specification for SCTP, Stewart, R., Ed., “Stream Control Transmission Protocol”, RFC 4960, DOI 10.17487/RFC4960, September 2007 (http://www.rfc-editor.org/info/rfc4960).

SCTP is layered over Internet Protocol (IP) and allows for multiple unidirectional data streams between connected endpoints. The individual streams can go in either direction, effectively providing bi-directional communication. The endpoints themselves may use multiple IP addresses in support of multiple data paths for the same logical SCTP connection. Data on any particular stream is delivered to the application layer in units referred to as messages, which are numbered by a stream sequence number. “Chunks” in SCTP packets carry the messages; the chunks are numbered sequentially using a transmission sequence number (TSN) that increases independently of which stream a chunk carries data for. An SCTP packet will generally carry multiple and different kinds of chunks. The possible chunk types include DATA chunks, which carry payload data. Chunks are a protocol concept not seen by applications, which read messages from and write messages to the SCTP stack. Like TCP/IP, there are acknowledgments sent that indicate data chunk reception, these are called selective acknowledgments or SACKs; and data chunks deemed to be lost are retransmitted. A few of the key parameters that capture the protocol state for data flow are the TSN, stream ID, stream sequence number, and various SACK fields.

SCTP additionally defines control messages and state machines both to establish and to cleanly teardown connections.

### SUMMARY

This specification describes technologies for implementing a system that includes data processing nodes that communicate using SCTP and possibly other protocols. A node is a physical computing device, e.g., a computer, or a virtual computing device running on a physical computing device, with one or more processors that can execute computer program instructions and memory for storing such instructions and data.

One use case, which will be the basis of most of the description in this specification, is a resilient implementation in an LTE Home eNodeB Gateway (HeNB-GW or HGW). The underlying context for this use case is the network architecture of a Long Term Evolution (LTE) system. The LTE architecture and its components and operation are described, for example, in the ETSI TS 136 300 v12.6.0 Release 12 (2015-07) Technical Specification, ©European Telecommunications Standards Institute (ETSI) 2015 (“ETSI LTE”), the disclosure of which is incorporated herein by reference.

The resilient HGW is resilient in the sense that if an active HGW instance suddenly ceases operation, for whatever reason, a new HGW instance can replace it without requiring the reset or reconnection of key control connections that had been established between external entities and the original HGW. It is important to insure that established connections are resilient because of the much greater cost incurred in resetting a connection on which data is already flowing, or an aggregation of connections coming through an SCTP channel, as opposed to restarting a failed connection attempt. For this reason, the resiliency for connected SCTP endpoints specifically is important.

This resiliency is achieved by an implementation of an SCTP stack that includes checkpoints, which will be referred to as a resilient SCTP stack. A resilient SCTP stack checkpoints key protocol state between a master and a slave at specific points, as chunks and messages flow through the network stack. Avoiding the overhead of maintaining the slave with state identical to that of the master at every instant, in the resilient SCTP stack, state is strategically checkpointed such that using the checkpointed state as a starting point, a replacement stack can be constructed at the slave, which, although not identical to the master, can continue without interruption from any failover point in a protocol-compliant manner. While the exact exchange of packets from a particular failover time will likely differ between those the original master stack would have generated, the protocol is capable of naturally adapting to these differences. For example, a newly promoted slave endpoint may perform additional retransmissions, but these would be in scope of retransmissions the SCTP protocol is designed to produce when data chunks are lost.

The innovative aspects of the subject matter described in this specification can be embodied in methods, computer programs on non-transitory media, and computer systems of one or more computers in one or more locations that are programmed with instructions that, when executed by the one or more computers, cause them to perform operations described in this specification. Programs and systems may be described in this specification as being “configured” to perform certain actions or processes. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. With a resilient SCTP stack as described in this specification, failover does not result in message loss, nor does failover result in duplicate message delivery to the application. With such an implementation of SCTP, checkpointing that results in data payload copying is minimized; for example, data moving within the stack from queue-to-queue is not checkpointed at every transition. In addition, the implementations of a resilient SCTP stack described in this specification are interoperable with existing SCTP implementations; the protocol specification is not violated, and it can be implemented so as not to deviate from timing assumptions made by industry standard implementations. Platforms interconnected with resilient implementations of SCTP control protocols can be grown across many generations of hardware with predictable scaling and near 100% availability. When critical network functionality is implemented on commodity servers, the resiliency designed into the SCTP protocol is insufficient. In contrast, the resilient implementations described in this specification provide resilient, non-disruptive failover of network functionality from one server or one rack to another. The SCTP protocol was designed for resiliency in use cases where failover is limited to a single appliance providing network functionality, and the failover is due to a single component failure such as a network adaptor. In contrast, the resilient implementations described in this specification apply to a data-center model of providing network functionality.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates master-slave checkpoint timing in the data transmission path between nodes implementing SCTP stacks, at least the sending one of which is a resilient SCTP stack.

FIG. 2 illustrates master-slave checkpoint timing in the data receiving path between nodes implementing SCTP stacks, at least the receiving one of which is a resilient SCTP stack.

FIG. 3 illustrates a use case for a resilient SCTP stack in an LTE network infrastructure.

FIG. 4 illustrates a particular implementation of checkpointing.

FIG. 5 illustrates the slave promotion process.

FIG. 6 illustrates a data send path in an implementation of master SCTP stack processing.

FIG. 7 illustrates a data receive path in an implementation of master SCTP stack processing.

Like reference numbers and designations in the various drawings indicate like elements.

### DETAILED DESCRIPTION

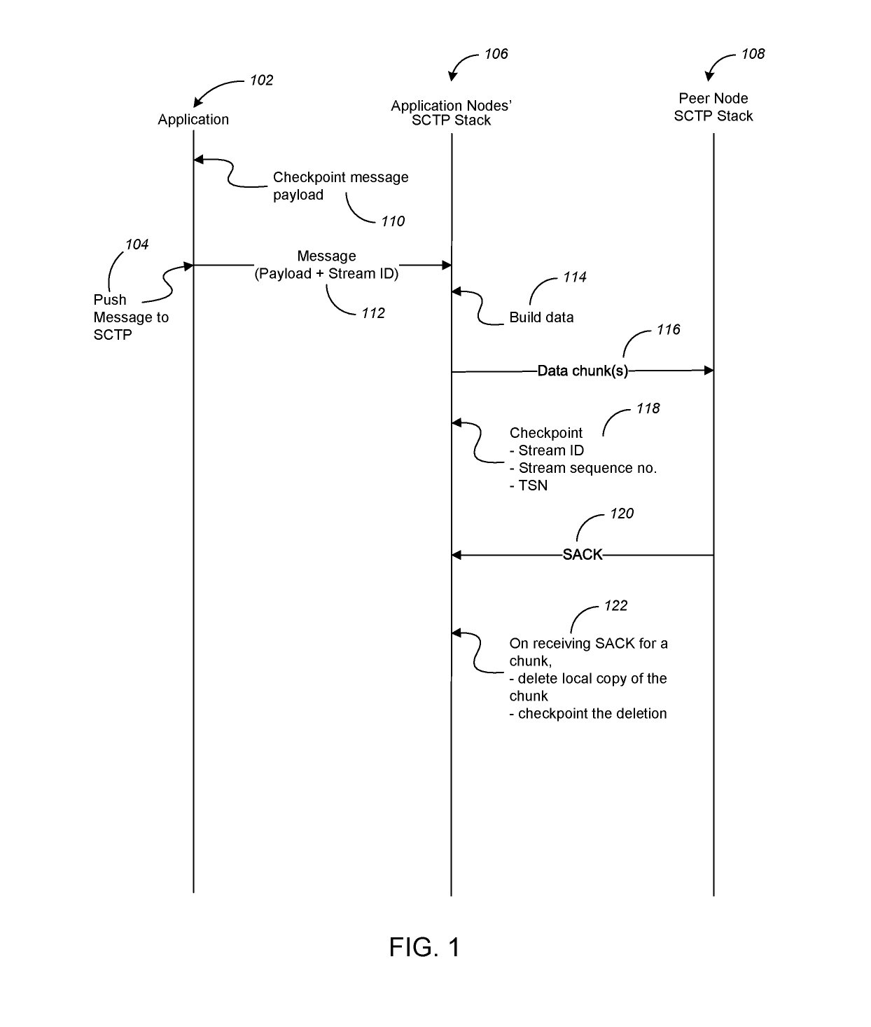

FIG. 1 illustrates master-slave checkpoint timing in the data transmission path between nodes implementing SCTP stacks, at least the sending one of which is a resilient SCTP stack. The figure shows the timing for an application 102 pushing 104 an SCTP stream message to the resilient SCTP stack 106. The resilient SCTP stack may be running on a node on which the application the stack is bound to is running, or on a different node. Generally, the application 102 and stack 106 will be running on the same node and in the same process. FIG. 1 further illustrates the protocol-level interaction between the application's node and that of an SCTP stack of the endpoint node 108 of the peer that is the application's recipient for the message. The SCTP stack of the endpoint node 108 may be, but generally will not be, a resilient SCTP stack.

All the checkpointing on the transmission path is to a slave for the transmitting, resilient SCTP stack 106 of the application node, which is the master. The slave is a standby node which is configured with an implementation of the resilient SCTP stack and which may be further configured to receive and archive checkpoint data from the master. Alternatively to storing the checkpoint data in the slave stack, the checkpoint data may be stored on storage local to the slave node. The slave node will generally be on a different server and advantageously in a different rack in a datacenter than the master node. The different rack will advantageously provide the slave node with one or more of a power supply, a source of power, or a network connection that is different from that used by the master node. The checkpointing operations archive the checkpointed data in case the data needs to be retransmitted.

The actual message payload is first checkpointed by the application, or by a wrapper on the SCTP stack send operation, and then pushed 104 to the SCTP protocol engine. The data chunks composing the message are built 114 and sent 116, and following this the stream ID, stream sequence number, and TSN associated with the message chunks are checkpointed 118. When a SACK for a chunk is received from the peer, the application's SCTP stack 106 deletes its local copy of the chunk and checkpoints the deletion 122.

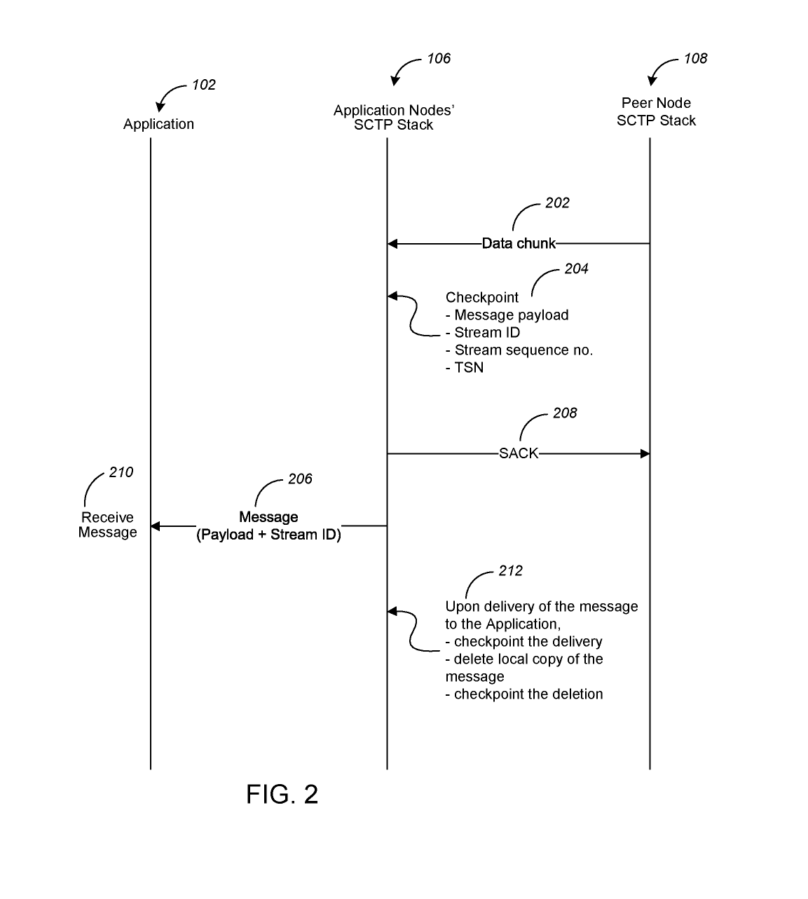

FIG. 2 illustrates master-slave checkpoint timing in the data receiving path between nodes implementing SCTP stacks, at least the receiving one of which is a resilient SCTP stack.

The application node's resilient SCTP stack 106 is receiving a message for the application. The message payload, stream ID, stream sequence number and TSN of each DATA chunk of the message are checkpointed 204 by the stack 106 to its slave after the DATA chunk is received 202 and before the stack 106 delivers 206 the entire message to the receiving application. After checkpointing 204 the receipt of a chunk 202, the stack 106 sends 208 a SACK to the peer indicating that the chunk has been received, since the slave now also has the received data. Finally, the stack 106 delivers 206 the message to the application 210 when all DATA chunks of the message have been received. The stack 106 checkpoints 212 the delivery of the message, deletes its local copies of the associated DATA chunks, and checkpoints 212 the deletion of the associated DATA chunks.

The resilient SCTP stack implementation is preferably done in user-space, because performing the checkpointing operations within a kernel-space would be more difficult, and in addition, working in user-space provides greater freedom in coupling the SCTP stack to critical applications.

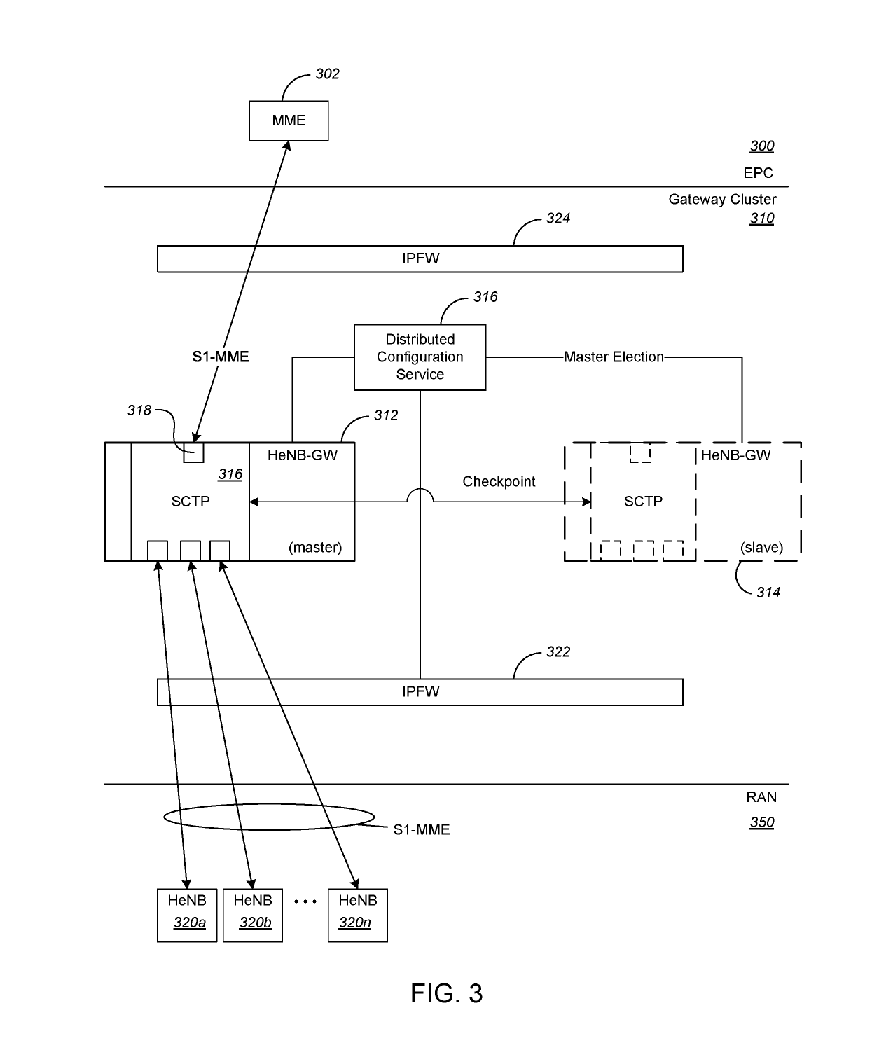

FIG. 3 illustrates a use case in which the resilient SCTP stack provides particular advantages, namely a resilient SCTP implementation in an LTE Home eNodeB Gateway (HeNB-GW or HGW). The underlying context for this use case is the network architecture of a Long Term Evolution (LTE) system, a wireless broadband infrastructure technology.

Illustrated is a single Mobility Management Entity (MME) 302 in the Evolved Packet Core (EPC) 300 of an LTE implementation. The EPC will have other elements, including, generally, multiple MMEs. An MME is responsible for keeping track of all user equipment, in particular, handsets. The breaking of a conventional SCTP connection to the MME would mean all of the services through the connection would have to reattach. The resilient failover provided by the resilient SCTP stack prevents this.

Outside of the EPC is a gateway cluster infrastructure 310, that may be implemented on datacenter equipment on which are deployed, i.a., multiple LTE Home eNodeB Gateways (HeNB-GWs or HGWs) 312. For each HGW that is designated as a master, another HGW is designated as its slave 314. Which is the master and which the slave is determined by a distributed configuration service 316, which may be implemented using Apache ZooKeeper, a software project of the Apache Software Foundation. Apache ZooKeeper, ZooKeeper, and Apache are trademarks of The Apache Software Foundation.

The distributed configuration service 316 is used to assign a lock between two nodes that designates one of them as the master. The service also synchronizes actions between cooperating nodes. The service is preferably implemented using an ensemble of ZooKeeper servers, which appear to the HGWs as one service. When a currently-designated master HGW 312 fails, the slave HGW 314 learns from the service that it, the slave, has been promoted and is now that master. The newly promoted master or some other entity creates a new instance of HGW or designates an existing instance to be the new slave.

In some implementations, this election of a master and creation of a new instance are done as follows. A scheduler process is configured, e.g., by a configuration file, to have a predetermined number, e.g., three or five, HGWs running at a time. When an HGW instance terminates, the scheduler processor launches another instance. The HGW instances coordinate with each other using Zookeeper, which provides a name space of data registers called znodes. The instances use the znodes to store their configuration information, including the configuration information specifying where message payloads should be checkpointed. This information is available to the application. The instances also use a Zookeeper recipe for leader election, e.g., as described in http://zookeeper.apache.org/doc/current/recipes.html.

The MME 302 communicates with the HGW 312; in particular, it sees only whichever one of the master-slave pair is currently the master. It communicates with the HGW 312 over an S1-MME control plane interface. The S1-MME interface stack includes an SCTP layer and the MME 302 communicates with the HGW 312 through a separate SCTP connection 318 to the resilient SCTP stack 316 in the HGW 312.

Similarly, each of multiple HeNBs 320a, 320b, . . . 320n communicate with the HGW 312 through their own separate connections to the resilient SCTP stack 316. Each HeNB is a Home evolved Node B, described in the ETSI LTE standard, cited earlier. HeNBs are small cells deployed outside the datacenter and are part of an LTE radio access network (RAN) 350 that communicate directly with mobile handsets.

The MME 302 and the HeNBs 320a . . . 320n implement a conventional SCTP stack.

The infrastructure advantageously includes an IP forwarder (IPFW) 322 between the master and slave HGW, on the one hand, and the HeNBs attached to the master HGW 312, on the other hand. The IPFW 322 makes the connections to the HGW 312 or the HGW 314 look the same whether the connection is to the master or slave, by maintaining a consistent IP address. The IPFW 322 thus makes a failover from master 312 to slave 314 appear transparent to the HeNBs. Advantageously, an IPFW 324 also sits between the MME 302 and master/slave HGW 312/314 for the same purpose. The IPFWs learn of the failover from master to slave HGW from the distributed configuration service 316. With this architecture, on failover of a master HGW to a slave, the handover of HeNBs from former master to former slave HGW can be accomplished without involving the EPC.

In some implementations, the IPFW implements a “distributed IP” address (DIP). A virtual MAC address is used on an externally facing interface on the IPFW, and Address Resolution Protocol (ARP) requests to the DIP are responded to by the IPFW. Each IPFW maintains a database of backend servers, and in particular a record of which servers are acting as master, utilizing a distributed storage infrastructure designed for this purpose, e.g., the deployment of Apache ZooKeeper. Incoming packets first arrive at the IPFW and are forwarded by the IPFW to the machine with the resilient SCTP stack. For the return path, the one carrying responses from the machine with the SCTP stack, packets go directly to the originator, bypassing the IPFW, and have the DIP as the source address. This same process is also used when the backend is the originator.

The SCTP master and slave, e.g., the HeNB-GW master 312 and slave 314 are a pair of such backend servers. Alternatively, the master and slave can simply perform the same virtual MAC operations and do not necessarily require a forwarder in the path, but the forwarder can additionally provide other valuable services, for example, load-balancing.

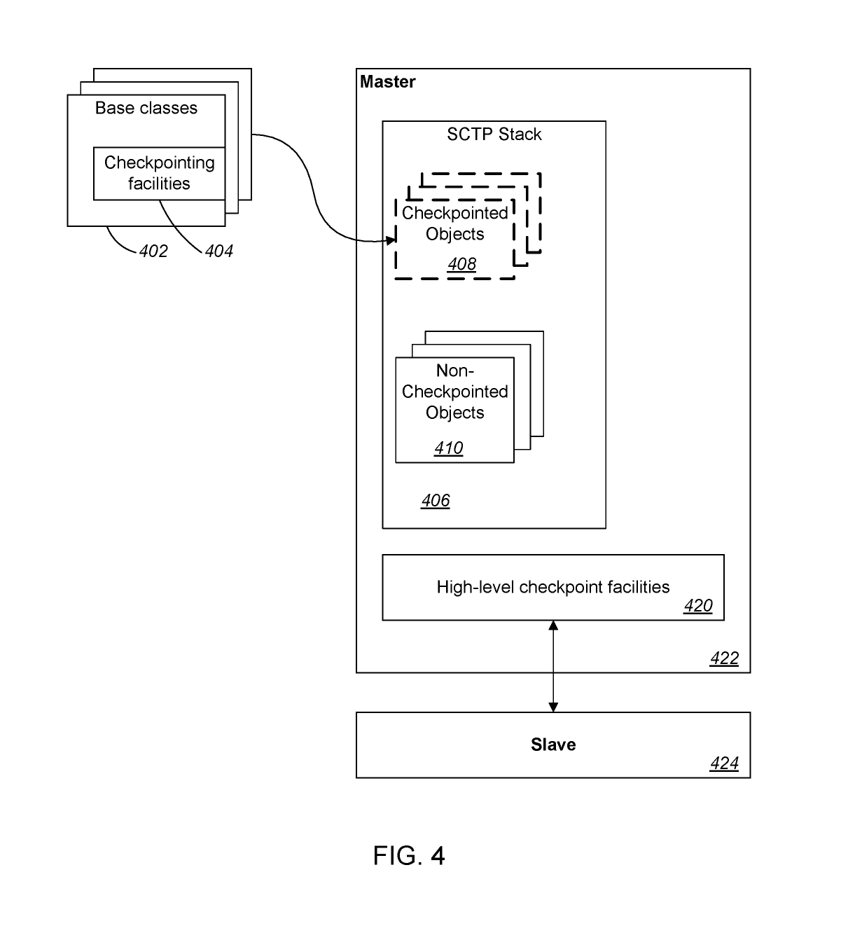

FIG. 4 illustrates a particular implementation of checkpointing. In this implementation, the checkpointing strategy is an extension to object-oriented design methodologies used to implement the SCTP stack 406. The stack is implemented by a collection of objects, e.g., using C++, which can either be checkpointed 408, or not 410. The checkpointed objects derive from base classes 402 that provide checkpointing facilities 404. A checkpointed object itself will generally be composed of both checkpointed and non- checkpointed state; the checkpointed state is explicitly declared.

High-level checkpointing facilities 420 provide for connectivity between the master 422 and slave 424. The master has operational checkpointed objects 408. The creation and destruction of checkpointed objects is recorded by the high-level checkpointing facilities as checkpointed state changes at the master. In addition, as checkpointed state is modified due to stack operation at the master, the checkpointing facilities of the checkpointed objects record the changes. At particular instances, the high-level checkpointing facilities 420 of the master explicitly commits updates containing these changes by sending the updates to the slave. To guarantee consistency, the master, or at least the thread performing the checkpoint update, pauses until the checkpoint update operation completes.

At the slave 424, as checkpoint updates are received, objects in use by the master come and go, i.e., are created and held in a list at the slave until later deletion, as they are created and deleted at the master. The slave representation of each object through this process only contains the checkpointed state. It is during the process of promoting a slave to master that a non-checkpointed state, i.e., a full state, is created. This promotion process will now be described.

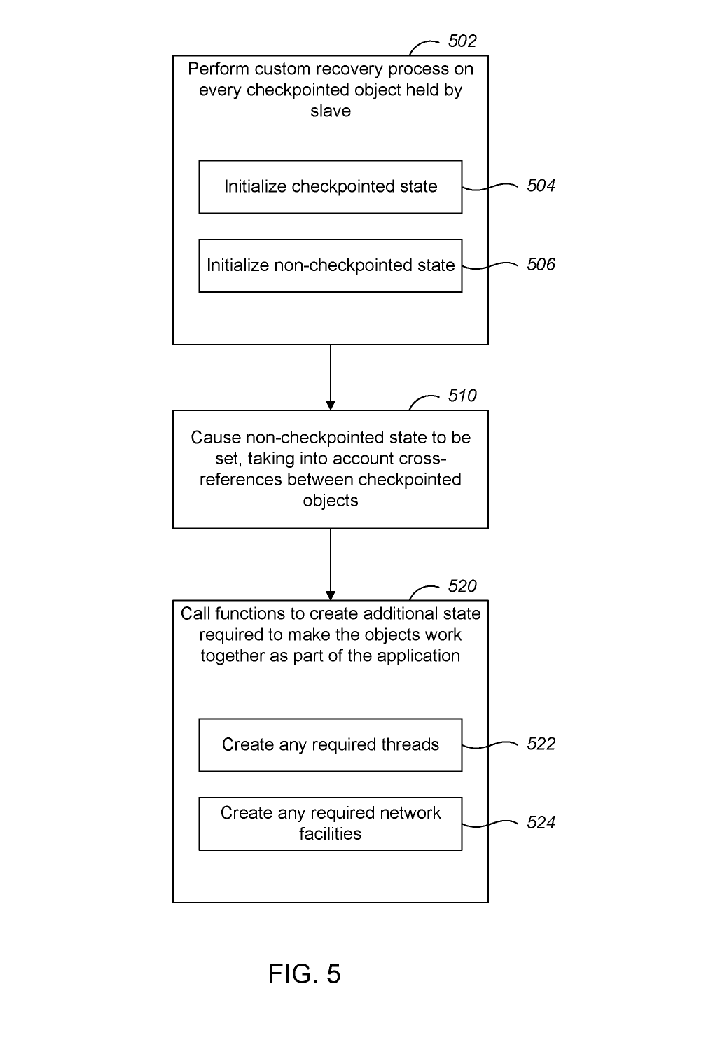

FIG. 5 illustrates the slave promotion process. The slave promotion process proceeds in three phases. First, for every one of the checkpointed objects held by the slave, a custom recovery function implemented on the object is called 502 by the checkpointing framework. This custom recovery function recreates a full object and at this point initializes the checkpointed 504 state 506.

In the second phase, the process causes the non-checkpointed state to be set to reasonable values given the values of the checkpointed state in a way that takes into account cross-references between checkpointed objects 510. For every one of the checkpointed objects whose custom recovery function was called in the first stage, a second custom recovery function is called. The second custom recovery function is specific for each object type, unlike the generic implementation of the custom recovery function, and this second custom recovery function may assume all checkpointed objects it references have had the first recovery function called. The second recovery function is coded to operate like an object constructor having been called with enough arguments to construct the various objects it manages; however, rather than obtaining input parameters and state through arguments, that state is obtained from the checkpointed data already constructed on the object and the other checkpointed objects it references. For example, an object that manages the data-sending path may contain both checkpointed and non-checkpointed queues. At this stage, the non-checkpointed queues and the non-checkpointed data held within the object can be synthesized based on data in various cross-referenced checkpointed objects.

After the second phase, all the checkpointed objects that were operational at the master at the time of failover are present at the slave.

In the third phase, the application on the node being promoted calls additional functions that use the set of recovered, checkpointed objects to create the additional state required to enable the objects to work together as part of an application 520. These functions are called by the application as it prepares to become the master. These additional functions are part of the generic SCTP implementation, and the application using the stack calls these functions as part of the process of being promoted. This additional state in large part requires creating operating-system state. For example, any required threads are created at this point 522, and also any required network facilities, e.g., sockets used to connect network peers, are created 524.

At this end of the promotion process, the slave has a fully functional and running SCTP stack. While it may not be completely identical to that of the previous master, it is capable of continuing the SCTP connections without appearance of interruption.

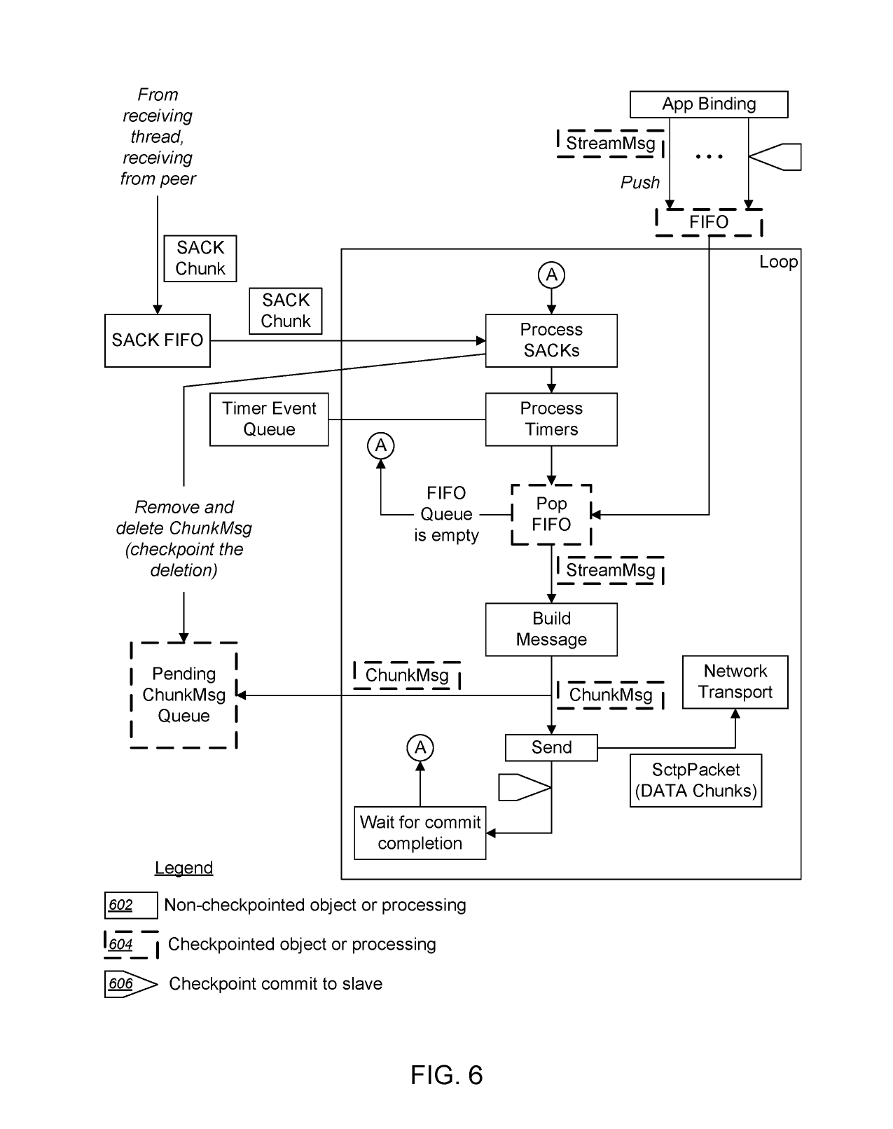

FIG. 6 illustrates a data send path in an implementation of master SCTP stack processing. This will be described with specific attention to the checkpointing strategy and objects used. The figure depicts the data flow through the send path, along with the primary processing blocks. As noted by the legend in the figure, the boxes and objects in plain outlines 602 represent non-checkpointed state and operations, the boxes in bold dashed outlines 604 represent checkpointed state and operations, and the wedges 606 identify points in the process where a thread commits all checkpointed changes accrued since the last commit to the slave.

To begin, the App Binding is the application entry point to the SCTP stack. The application may have more than one thread on which data send requests are made, which may be referred to as application threads, and an arrow emanating from this box represents each thread. Along each arrow, i.e., for each thread, a checkpointed StreamMsg object is created to capture the application data send request. This object contains the actual data to be sent, the association to send it on, and the SCTP stream number on which the data will be delivered. The association to send it on is also a checkpointed object; it is not shown in the diagram.

The StreamMsg is pushed onto a checkpointed FIFO queue that provides a bridge between the application thread or threads and the SCTP stack send thread. Before the “App Binding” function call that pushes the StreamMsg, i.e., that calls the FIFO's Push function, returns, a checkpoint commit sends the fact that the push operation occurred, as well as the actual data in the StreamMsg, to the slave. This occurs prior to further processing to insure that if the master fails after the push function returns, the data is not lost, i.e., the slave can be promoted and take over sending the data. This is the only time that the actual message data is checkpointed to the slave.

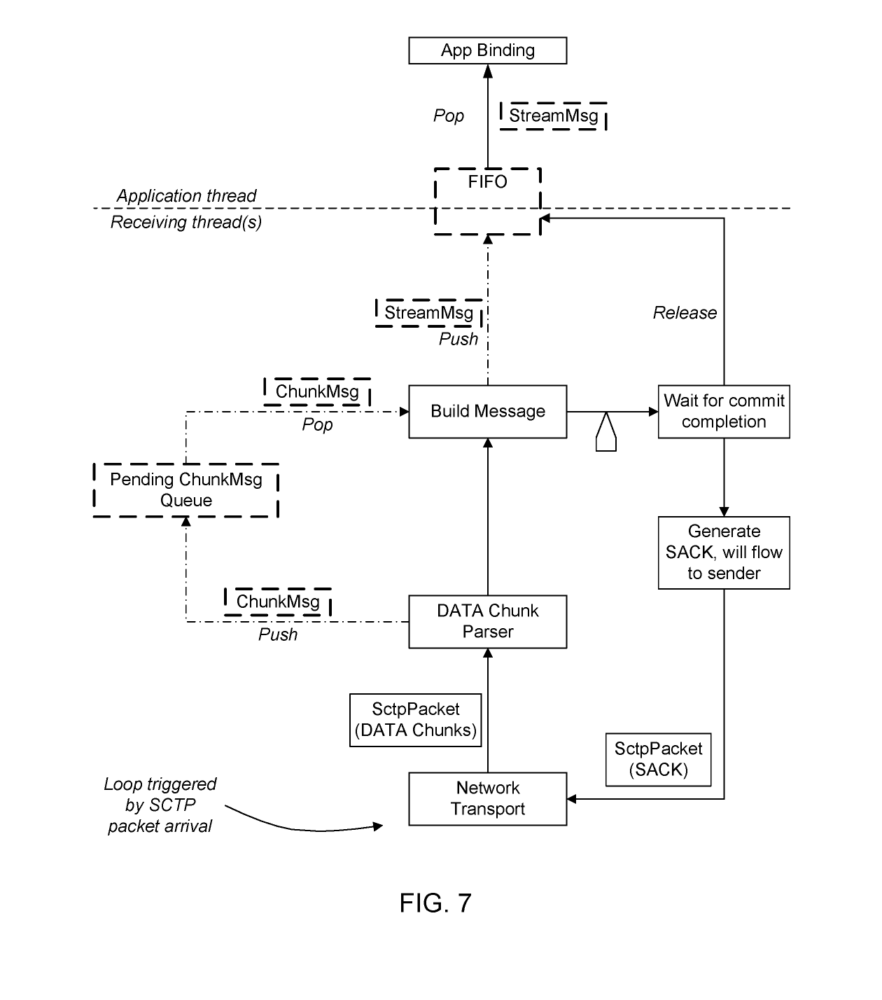

The processing within the box labeled “loop” represents the SCTP stack's single send thread. To begin the loop, all SACK chunks received from the SCTP peer are processed. The SACK chunks themselves arrive from a receiving thread, see FIG. 7, that has placed them onto the SACK FIFO. None of the SACK processing or SACK chunk objects need to be checkpointed, because SACK loss is naturally handled by the SCTP protocol. Processing of SACK objects can result in deletion of checkpointed data in the Pending ChunkMsg Queue, which will be described below. The data, after being acknowledged, no longer must be retained for resend operations.

The next processing to occur is that timers for the protocol are processed in the Process Timers block. Timer events are stored on a Timer Event Queue, and both the timer event and the queue are not checkpointed. Timer events include events such as data resends and heartbeat messages. The timers do not need to be checkpointed, because they can be reset to reasonable values when a slave is promoted to master without causing data or connection loss.

Next, the StreamMsg from the FIFO is popped. The operation itself is checkpointed on the FIFO, and if there are no messages to pop, the loop returns to start over at “A” in the figure. After the StreamMsg has been popped, it is used by the Build Message block to build a checkpointed ChunkMsg. Ownership of the StreamMsg data has now been transferred to the ChunkMsg to avoid duplicate data checkpointing, and the ChunkMsg now contains SCTP parameters relating to sending the message as chunks, such as the TSN. The ChunkMsg is placed on the Pending ChunkMsg Queue, where it will be held until it is acknowledged by the SCTP peer, at which time it may be deleted. SCTP message fragmentation on the send path is realized by having the StreamMsg result in a sequence of ChunkMsgs, if need be.

Finally, the Send operation prepares a non-checkpointed SCTP packet with the chunk for sending on the Network Transport, which sends it to the SCTP peer. At the end of the Send operation, once the network transport has been initiated, all checkpointed state that has changed during this pass through the loop is committed to the slave.

FIG. 7 illustrates a data receive path in an implementation of master SCTP stack processing. This will be described with specific attention to the checkpointing strategy and objects used. The figure depicts the data flow through the receive path, along with the primary processing blocks. As noted by the legend in FIG. 6, the boxes and objects in plain outlines 602 represent non-checkpointed state and operations, the boxes in bold dashed outlines 604 represent checkpointed state and operations, and the wedges 606 identify points in the process where a thread commits all checkpointed changes accrued since the last commit to the slave. In addition, the dot-dash directed connectors in FIG. 7 indicate a flow of data and not a processing flow.

The receiving thread loop begins by waiting in the Network Transport for the arrival of an SCTP packet that contains DATA chunks. Once DATA chunks are available for processing, a checkpointed ChunkMsg is created by the Data Chunk Parser to hold the chunks. This is the only point at which the actual data checkpointing occurs. The resulting ChunkMsg is pushed to the checkpointed Pending ChunkMsg Queue.

Processing continues in a Build Message process, which analyzes the Pending ChunkMsg Queue to determine whether any chunks are ready to be delivered to the application, i.e., whether the SCTP message with the next stream sequence number can be formed. This queue allows for handling out-of-order reception and fragmentation. All chunks forming an SCTP message are popped, and ownership of their data is transferred to the output StreamMsg, which will be used to deliver the SCTP message to the application.

After Build Message pushes the StreamMsg to the FIFO, which bridges the receive and application threads, the receiving thread spawns a checkpoint commit operation. The thread then waits for this checkpoint to complete before releasing the StreamMsg to the application and generating the SACK. The release of the StreamMsg signals to the application thread that data is available to pop. In some implementations, the pop call of the application thread will block, assuming nothing on the FIFO has been released already, until the receiving thread makes a release call on the FIFO. It is important to wait for the commit to complete, since otherwise: (i) the thread could end up delivering the same SCTP message multiple times if failover occurs at inopportune times; and (ii) the thread could SACK the chunk, which implies it will never be resent, yet failover not having checkpointed the data, the chunk would be lost forever.

After generating and sending the SACK chunk, the receiving thread again awaits the next SCTP packet containing data chunks to arrive.

Alternatively, the receive side can be implemented with multiple receiving threads that each push messages to the FIFO. In such implementations, the FIFO operates the same way as has been described for the send side, where multiple application threads push messages to the FIFO to be sent.

In both FIG. 6 and FIG. 7, the checkpointed objects are configured to operate in a multi-threaded environment. Every checkpointed object has an associated writer object that handles sending the object's checkpointed updates to the slave. To insure the slave maintains state that is consistent with the master, each thread has its own dedicated writer. This prevents race conditions that could exist between threads writing checkpoint information for a given object. Depending on the timing of threads writing checkpoints, and a master process becoming dysfunctional and requiring failover, the slave could otherwise end up missing a checkpoint due to out-of-sequence use of the writer by various threads. A specific example will be provided below describing the impact of this issue for the SCTP data send and receive paths.

A FIFO object, illustrated in FIG. 6 and FIG. 7, which itself is checkpointed, is used to pass checkpointed objects from one thread to another, and in doing so transition the writer of an object from one thread to the next. The FIFO semantics are as follows:
Thread A is initially using a checkpointed object (“O”), which has thread A's writer.
The FIFO push operation is used in thread A's context to place object O onto the FIFO. This push is a checkpointed operation which is recorded using thread A's writer. In some implementations, the FIFO uses the writer from the element being pushed to record the checkpointed push operation, then the next commit on the writer of the application thread will send the push operation to the slave along with all other checkpoints that have been accrued on this writer. Each object has a unique ID (UID) that is part of the checkpoint, so the slave knows which specific element has been pushed to which FIFO by this UID.
Thread A initiates a commit operation to the slave using thread A's writer; the commit will include the updates to object O since the previous commit and the push operation.
The FIFO release operation is executed in thread A's context, optionally waiting for the above commit operation initiated by thread A to complete.
Thread B, the thread that ultimately will take control of the object, uses a pop operation on the FIFO to obtain the object O. In the process, the FIFO insures that upon the completion of the pop operation, object O now has thread B's writer, which has replaced that of thread A.

The checkpointed FIFO in the above description has thread B's writer, because it was instantiated with thread B's writer. Every checkpointed object is assigned a writer when the object is instantiated. In addition, thread B's pop operation on the FIFO can be initiated before object O is released by the release operation, in which case thread B will wait for a predetermined amount of time on the release operation being executed by thread A. If this amount of time elapses before a release operation is executed, the pop operation returns without having retrieved any objects placed in the FIFO by thread A. Upon a slave being promoted to master, there is an implicit release call for all objects held by the FIFO at the slave.

The importance of the checkpointed FIFO object for passing objects between threads can be seen in the following example sequence of events in the case of only using a single writer between the application and data sending threads, without using the checkpointed FIFO semantics. Object O is pushed to a regular non-checkpointed FIFO by thread A, and a commit operation is performed for O using thread A. Thread B performs a pop, and at some point after the pop Thread B initiates a commit. The scheduling of threads A and B happens to result in thread B actually committing to the slave before thread A does, and the master happens to crash before the commit of A ever reaches the slave.

In that scenario, on the slave being promoted, due to the missing checkpoint of the commit of thread A, the application side of the FIFO has no record of ever sending the message, so will send the message again. However, the message send has been recorded by thread B; so on the slave being promoted, the message is in the queue and will be resent. The end result is that the message will be sent in duplicate, i.e., the same SCTP message data will be sent in multiple SCTP DATA chunks, each with a different TSN, which is a violation of the SCTP protocol stack API.

Similarly for the data receive path, a message could be delivered in duplicate to the application. In addition to these issues, it is also possible to have sent different messages using the same DATA chunk TSN, which would effectively cause message loss on the send path.

The design and the use of threading depicted in FIG. 6 and FIG. 7 achieves a good balance between simplicity and performance. The checkpointing strategy is not overly complex, and the only property of the SCTP stack that has been given up is the ability to perform dynamic QOS between streams. On the other hand, dedicating a separate thread for receiving and sending allows one of the two to proceed while the other would possibly be blocked awaiting a checkpoint to complete or other processing, and achieves good use of the hardware send and receive capabilities.

Optionally, even more threads could be used in the implementation, especially for the data receive path; however, this would lead to a much more complicated design that would be very difficult to thoroughly validate and test. Further, the design described above for data send and receive is the most straightforward when the checkpointed FIFOs are used in a manner where their release call is not made until confirmation from the slave that the checkpoint has completed. This has a relatively small impact on performance for the common case when the network used for writing checkpoints, which is usually intra-cluster, provides much higher performance than that of the network connecting the SCTP peers. Using a single thread for receive, and having the application side of the FIFO also use a single thread for the data send path, enables further optimization that allows the pushing thread not to wait for a commit acknowledgement from the slave before calling the FIFO release function.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous. Although described in the context on an LTE implementation, the resilient SCTP technology is much more widely applicable, and would be a key component for any data-center application requiring a resilient SCTP network stack.

What is claimed is:

1. A system comprising:
a plurality of nodes, wherein each node is an LTE Home eNodeB-GW (HeNB-GW) node that includes control protocols in a control plane protocol stack, the control protocols including the Stream Control Transmission Protocol (SCTP);
wherein a first node of the plurality of nodes has
(i) control connections to one or more other entities in an LTE architecture over interfaces using the control protocols, and
(ii) a connection to a synchronization service;
wherein a second node of the plurality of nodes also has a connection to the synchronization service;
wherein, when the first node is operating as a master and the second node is operating as a slave, as determined by the synchronization service, the first node performs checkpoint operations to checkpoint key protocol state, the checkpoint operations including:
for transmissions on a transmission path over an SCTP connection from the master to a peer, checkpointing state as follows:
checkpointing a message payload of a message when the message is received from an HeNB-GW application and before the message is pushed to an SCTP stack for transmission to the peer;
after message data is transmitted to the peer by the SCTP stack as one or more chunks, checkpointing a stream ID, a stream sequence number, and a transmission sequence number (TSN) of the transmitted data; and
upon each receipt of a selective acknowledgement (SACK) that a particular transmitted chunk has been received by the peer, deleting the checkpointed particular chunk data and checkpointing this deletion;
for receptions of data on a receive path over an SCTP connection from the peer to the HeNB-GW application, checkpointing state as follows:
upon receipt of a data chunk from the peer, checkpointing a message payload, a stream ID, a stream sequence number, and a TSN of the data chunk to the second node before sending a SACK for the data chunk to the peer; and
upon a delivery of a message to the HeNB-GW application, deleting the message from the SCTP stack and checkpointing the deletion.

2. The system of claim 1, wherein the checkpointing operations in the first and second nodes are performed by instructions executing in user space.

3. The system of claim 2, wherein the second node operating as a slave is configured to respond to a failover by performing recovery operations to construct a replacement stack on the second node so that the second node can continue without interruption from a failover point of the first node in an SCTP-protocol-compliant manner.

4. The system of claim 3, wherein the recovery operations comprise:
for each checkpointed object held by the slave:
calling a custom recovery function implemented on the object, the custom recovery function recreates a full object and initializes the checkpointed state of the full object.

5. The system of claim 4, wherein the recovery operations comprise:
for each checkpointed object held by the slave whose custom recovery function has been called:
calling a second custom recovery function that obtains state information from checkpointed data already constructed on the object and any other checkpointed objects that the object references; and
synthesizing any non-checkpointed queues and any non-checkpointed data held within the object based on data in referenced checkpointed objects that the object references.

6. The system of claim 5, wherein:
each object type has a specific second custom recovery function.

7. The system of claim 6, wherein:
the peer is an LTE Mobility Management Entity (MME) or an LTE Home eNodeB (HeNB).

8. The system of claim 1, wherein:
each of the nodes of the plurality of nodes is deployed in a datacenter and is configured to connect, when operating as a master, to an LTE Mobility Management Entity (MME) in an LTE Evolved Packet Core (EPC) network through a first IP forwarder (IPFW) and to multiple Home eNodeBs (HeNBs) in an LTE Radio Access Network (RAN) through a second IPFW; and
the synchronization service has a connection to the first IPFW and a connection to the second IPFW.

9. The system of claim 8, wherein, on a failure of the first node operating as a master:
the second node determines from the synchronization service determines that the second node shall operate as a master;
the first IPFW connects the MME to the second node in place of the first node; and
the second IPFW connects the multiple HeNBs to the second node in place of the first node.

10. The system of claim 9, wherein:
the first IPFW connects the MME to the second node in place of the first node in response to an alert sent to the first IPFW, in response to which the first IPFW determines that the first IPFW should communicate with the second node and not the first node as master; and
the second IPFW connects the multiple HeNBs to the second node in place of the first node in response to an alert sent to the second IPFW, in response to which the second IPFW determines that the second IPFW should communicate with the second node and not the first node as master.

11. The system of claim 8, wherein the first IPFW and the second IPFW are the same IPFW instance.

12. The system of claim 8, wherein the first IPFW and the second IPFW are distinct IPFW instances.

13. The system of claim 1, wherein:
the synchronization service is a replicated synchronization service;
the replicated synchronization service an Apache ZooKeeper service instance; and
the first node and the second node are connected to the synchronization service as clients of the Apache ZooKeeper instance.

14. A system comprising:
a plurality of nodes, including (i) a master node running an application communicating with one or more peers over the Stream Control Transmission Protocol (SCTP) and (ii) a slave node configured to replace the master in the event of a failure of the master;
wherein the master node and the slave node each have a connection to a synchronization service;
wherein the master node performs checkpoint operations to checkpoint key protocol state, the checkpoint operations including:
for transmissions on a transmission path over an SCTP connection from the application to a peer, checkpointing state as follows:
checkpointing a message payload of a message when the message is received from the application and before the message is pushed to an SCTP stack on the master for transmission to the peer;
after message data is transmitted to the peer by the SCTP stack as one or more chunks, checkpointing a stream ID, a stream sequence number, and a transmission sequence number (TSN) of the transmitted data; and
upon each receipt of a selective acknowledgement (SACK) that a particular transmitted chunk has been received by the peer, deleting the checkpointed particular chunk data and checkpointing this deletion;
for receptions of data on a receive path over an SCTP connection from the peer to the application, checkpointing state as follows:
upon receipt of a data chunk from the peer, checkpointing a message payload, a stream ID, a stream sequence number, and a TSN of the data chunk to the second node before sending a SACK for the data chunk to the peer; and
upon a delivery of a message to the application, deleting the message from the SCTP stack and checkpointing the deletion.

15. The system of claim 14, wherein the checkpointing operations in the first and second nodes are performed by instructions executing in user space.

16. The system of claim 14, wherein the second node operating as a slave is configured to respond to a failover by performing recovery operations to construct a replacement stack on the second node so that the second node can continue without interruption from a failover point of the first node in an SCTP-protocol-compliant manner.

17. The system of claim 16, wherein the recovery operations comprise:
for each checkpointed object held by the slave:
calling a custom recovery function implemented on the object, the custom recovery function recreates a full object and initializes the checkpointed state of the full object.

18. The system of claim 17, wherein the recovery operations comprise:
for each checkpointed object held by the slave whose custom recovery function has been called:
calling a second custom recovery function that obtains state information from checkpointed data already constructed on the object and any other checkpointed objects that the object references; and
synthesizing any non-checkpointed queues and any non-checkpointed data held within the object based on data in referenced checkpointed objects that the object references.

19. The system of claim 18, wherein:
each object type has a specific second custom recovery function.

20. The system of claim 14, wherein:
each of the nodes of the plurality of nodes is deployed in a datacenter and is configured to connect, when operating as a master, to a first peer through a first IP forwarder (IPFW) and to multiple second peers through a second IPFW; and
the synchronization service has a connection to the first IPFW and a connection to the second IPFW.

21. The system of claim 20, wherein, on a failure of the first node operating as a master:
the second node determines from the synchronization service determines that the second node shall operate as a master;
the first IPFW connects the first peer to the second node in place of the first node; and
the second IPFW connects the multiple second peers to the second node in place of the first node.

22. The system of claim 21, wherein:
the first IPFW connects the first peer to the second node in place of the first node in response to an alert sent to the first IPFW, in response to which the first IPFW determines that the first IPFW should communicate with the second node and not the first node as master; and
the second IPFW connects the multiple second peers to the second node in place of the first node in response to an alert sent to the second IPFW, in response to which the second IPFW determines that the second IPFW should communicate with the second node and not the first node as master.

23. The system of claim 20, wherein the first IPFW and the second IPFW are the same IPFW instance.

24. The system of claim 20, wherein the first IPFW and the second IPFW are distinct IPFW instances.

25. The system of claim 14, wherein:
the synchronization service is a replicated synchronization service;
the replicated synchronization service an Apache ZooKeeper service instance; and
the first node and the second node are connected to the synchronization service as clients of the Apache ZooKeeper instance.

26. A system comprising:
a plurality of nodes on which are deployed computer program instructions that are operable, when executed by the plurality of nodes, to cause one or more of the plurality of nodes to perform the operations comprising:
for transmissions on a transmission path over an SCTP connection from an application to a peer through a first SCTP stack instance, checkpointing state as follows:
checkpointing a message payload of a message before the message is acknowledged by the first SCTP stack instance for transmission to the peer;
after message data is transmitted to the peer by the first SCTP stack instance as one or more DATA chunks, checkpointing a stream ID, a stream sequence number, and a transmission sequence number (TSN) of the transmitted DATA chunks; and
upon each receipt of a selective acknowledgement (SACK) that a particular transmitted DATA chunk has been received by the peer, deleting the checkpointed particular DATA chunk and checkpointing this deletion;
for receptions of data on a receive path over an SCTP connection from the peer to the application through the first SCTP stack instance, checkpointing state as follows:
upon receipt of a DATA chunk from the peer, checkpointing a message payload, a stream ID, a stream sequence number, and a TSN of the DATA chunk before sending a SACK for the DATA chunk to the peer; and
upon a delivery of a message to the application, deleting the message from local memory of the first SCTP stack instance and checkpointing the deletion.

27. The system of claim 26, the operations further comprising:
maintaining a first connection between a first node running the first SCTP stack instance and a synchronization service and maintaining a second connection between a second node running a second SCTP stack instance and the synchronization service.

28. The system of claim 27, the operations further comprising:
receiving an alert from the synchronization service indicating that the second node should operate as a master.

29. The system of claim 27, the operations further comprising:
responding to a failover from the first node to the second node by performing recovery operations to construct a replacement stack on the second node so that the second node can continue without interruption from a failover point of the first node in an SCTP-protocol-compliant manner.

30. The system of claim 26, the operations further comprising:
performing the checkpoint operations by instructions executing in user space of the first node.

31. A system comprising:
a computing node, the node running an application, the node having instructions that are operable, when executed by the node, to cause the node to perform operations comprising:
for each of a plurality of application messages sent by the application for transmission to a respective one of one or more peers, wherein each application message is sent by the application on one of a plurality of application threads, each application thread has a writer, and each application message has the writer of the corresponding application thread,
performing on the corresponding application thread a push operation onto a FIFO queue, and checkpointing this push operation using the writer of the application message on the corresponding application thread;
by a send thread different from the application threads:
performing a pop operation to pop each application message from the FIFO queue, and associating the send thread with the popped application message;
building one or more chunk messages from the application message and checkpointing the chunk messages; and
transmitting the one or more chunk messages to the respective peer.

32. The system of claim 31, wherein:
the applications threads and the send thread perform the push and pop operations on a FIFO object that maintains the FIFO queue; and
the FIFO object makes the popped application message have the writer of the send thread.

33. The system of claim 31, wherein:
the application threads and the send thread are running in a process in a master node; and
the checkpointing is to a slave process on a slave node different from the master node.

34. The system of claim 33, wherein
the checkpointing including a commit operation to the slave process, wherein the commit operation sends a list of accrued changes by checkpointed objects, each checkpointed object is uniquely identifiable by a unique identifier, on a writer of the object.

35. The system of claim 34, wherein the commit operation initiated on the master node, and the master node receives an acknowledgement from the slave node that the commit has been received and processed.

36. A system comprising:
a computing node, the node running an application, the node having instructions that are operable, when executed by the node, to cause the node to perform operations comprising:
for each of a plurality of application messages sent to the application from a respective one of one or more peers, wherein each application message is received by the application on an application thread that has a writer for application messages,
receiving the message in chunks by a receiving thread different from the application thread, including:
receiving one or more chunk messages from the respective peer, and
building the application message from the chunk messages;
performing a push operation by the receiving thread to push each application message onto the FIFO queue;
checkpointing the push operation using a writer of the application message on the receiving thread;
performing a pop operation by one of the application thread to pop the application message from the FIFO queue; and
checkpointing the pop operation using the writer of the application message on the one of the application thread.

37. The system of claim 36, wherein:
the applications thread and the receiving thread perform the push and pop operations on a FIFO object that maintains the FIFO queue; and
the FIFO object makes the popped application message have the writer of the application thread that popped the application message.

38. The system of claim 36, wherein:
the application thread and the receiving thread are running in a process in a master node; and
the checkpointing is to a slave process on a slave node different from the master node.

39. The system of claim 38, wherein the receiving thread is one of a plurality of receiving threads running in the process in the master node.

40. The system of claim 38, wherein the checkpointing includes a commit operation to the slave process, wherein the commit operation sends a list of accrued changes by checkpointed objects, each checkpointed object is uniquely identifiable by a unique identifier, on a writer of the object.
